(19) United States
(12) Patent Application Publication
(10) Pub. No.: US 2018/0281654 A1
(43) Pub. Date: Oct. 4, 2018

(54) APPARATUS FOR DRINK CONTAINER

(71) Applicant: Dwayne Lee Adams, Waubaushene (CA)

(72) Inventor: Dwayne Lee Adams, Waubaushene (CA)

(21) Appl. No.: 15/477,421

(22) Filed: Apr. 3, 2017

(51) Int. Cl. B60N 3/10

(52) U.S. Cl. CPC B60N 3/102

(57) ABSTRACT

An apparatus includes a flexible absorbent panel configured to surround, at least in part, a drink container. The drink container is configured to receive a liquid therein. The flexible absorbent panel is also configured to surround, at least in part, the drink container. The flexible absorbent panel is also configured to absorb, at least in part, the liquid once the flexible absorbent panel is positioned, at least in part, proximate to the drink container, and the liquid is inadvertently spilled from the drink container.

### TECHNICAL FIELD

This document relates to the technical field of (and is not limited to) (A) an apparatus for a drink container, (B) an apparatus for a drink container and for a cup receiver of a drink-holder assembly, and/or (C) an apparatus for a drink container and for a cup receiver of a drink-holder assembly of a vehicle.

### BACKGROUND

A cup holder is a device configured to hold a cup or a drinking vessel in a relatively stationary position (such as, securely on a desk or reference surface, etc.). The cup holder may be built into or retrofitted to, a vehicle, an automobile, a chair, a wall (such as, the wall of an airplane, a boat, a bus or a train).

### SUMMARY

It will be appreciated that there exists a need to mitigate (at least in part) at least one problem associated with the existing drink container (also called the existing technology). After much study of the known systems and methods with experimentation, an understanding of the problem and its solution has been identified and is articulated as follows:

The installation of cup holders in automobiles has increased significantly. People consider the design, location and number of cup holders in a vehicle to be an important attribute for influencing their vehicle purchase. Others take a contrary view that cup holders are not only irrelevant but encourage a dangerous practice that distracts drivers from their primary task (of driving, etc.). Cars designed primarily for the North American market have tended to have larger cup holders, while those for which the primary market is outside of North America tend to have smaller ones. However, as most cars are now built for a global market which includes the United States, many cars, such as in Europe, feature cup holders.

On a table or work desk, coffee cups can be knocked over by the person sitting and working at the desk by their arms or hands. This can happen very easily if the person is disturbed e.g. by a telephone call or by a sudden impulsive move. Coffee cups on desks can also be knocked over by pets such as dogs or cats who may jump up onto the desk. Coffee or tea can also spill out of a cup if the table is knocked by a person walking by.

To mitigate, at least in part, at least one problem associated with the existing technology, there is provided (in accordance with a first major aspect) an apparatus. In accordance with the first major embodiment, the apparatus includes (and is not limited to) a flexible absorbent panel. The flexible absorbent panel may be called a flexible liquid-receiving assembly. The flexible absorbent panel may include, for instance, a fabric or a cloth, etc., and any equivalent thereof. The flexible absorbent panel is configured to surround, at least in part, a cup receiver of a drink-holder assembly of a vehicle once the flexible absorbent panel is positioned proximate to the cup receiver. The vehicle may include, for instance, a car or a truck, etc., and any equivalent thereof. The cup receiver of the drink-holder assembly is configured to receive, at least in part, a drink container. The drink container may include, for instance, a paper cup, a metal container, etc., and any equivalent thereof. The drink container is configured to receive a liquid therein. The liquid may include, for instance, coffee, a hot beverage, a cold beverage, etc. The flexible absorbent panel is configured to surround, at least in part, the drink container once the flexible absorbent panel is positioned to surround, at least in part, the cup receiver of the drink-holder assembly, and the drink container is positioned, at least in part, in the cup receiver. The flexible absorbent panel is also configured to absorb, at least in part, the liquid once the flexible absorbent panel is positioned, at least in part, proximate to the drink container, and the liquid is inadvertently spilled from the drink container.

To mitigate, at least in part, at least one problem associated with the existing technology, there is provided (in accordance with a second major aspect) an apparatus. In accordance with the second major embodiment, the apparatus includes (and is not limited to) a synergistic combination of a flexible absorbent panel, a receiver assembly and a support assembly. The flexible absorbent panel provides a void. The void is configured to receive, at least in part, a drink container, and this is done in such a way that the flexible absorbent panel is positioned between a top section and a bottom section of the drink container. The drink container is configured to receive a liquid therein. The receiver assembly defines a mouth, and the mouth is configured to be received, at least in part, in a drink-holder assembly of a vehicle. The support assembly is configured to extend, at least in part, radially from the receiver assembly. The support assembly is also configured to selectively securely support, at least in part, the flexible absorbent panel in such a way that the support assembly, in use, positions, at least in part, the flexible absorbent panel at a position that is located proximate to the mouth of the receiver assembly. The flexible absorbent panel is configured to absorb, at least in part, the liquid once the flexible absorbent panel is positioned, at least in part, proximate to the drink container, and the liquid is inadvertently spilled from the drink container.

To mitigate, at least in part, at least one problem associated with the existing technology, there is provided (in accordance with a third major aspect) an apparatus. In accordance with the third major embodiment, the apparatus includes (and is not limited to) a synergistic combination of a flexible absorbent panel, a receiver assembly and a support assembly. The flexible absorbent panel provides, at least in part, a void. The void is configured to receive, at least in part, a drink container, and this is done in such a way that the flexible absorbent panel is positioned between a top section and a bottom section of the drink container. The drink container is configured to receive a liquid therein. The receiver assembly is configured to be received, at least in part, in a drink-holder assembly of a vehicle. Preferably, the receiver assembly is configured to be supported, at least in part, by the drink-holder assembly. The receiver assembly includes a vertically-extending lateral side wall having an upper wall portion and a lower wall portion. The upper wall portion provides, at least in part, a mouth. The mouth is configured to receive, at least in part, the drink container. The mouth is also configured to be positioned, at least in part, proximate to the vertically-extending lateral side wall of the receiver assembly. The mouth is also configured to correspond, at least in part, with the void of the flexible absorbent panel, and this is done in such a way that the mouth is registered, at least in part, with the void once the void of the flexible absorbent panel is positioned proximate to the mouth of the receiver assembly. The support assembly may be called a flap structure. The support assembly is configured to extend, at least in part, radially from the vertically-extending lateral side wall of the receiver assembly. The support assembly is also configured to contact, at least in part, the vertically-extending lateral side wall of the receiver assembly. The support assembly is also configured to surround, at least in part, the vertically-extending lateral side wall of the receiver assembly. The support assembly is also configured to selectively securely support, at least in part, the flexible absorbent panel in such a way that the support assembly, in use, positions, at least in part, the flexible absorbent panel at a position that is located proximate to the mouth of the receiver assembly. The flexible absorbent panel is also configured to absorb, at least in part, a liquid once the flexible absorbent panel is positioned, at least in part, proximate to the drink container, and the liquid is inadvertently spilled from the drink container.

To mitigate, at least in part, at least one problem associated with the existing technology, there is provided (in accordance with a fourth major aspect) an apparatus. In accordance with the fourth major embodiment, the apparatus includes and is not limited to (comprises) a flexible absorbent panel. The flexible absorbent panel is configured to surround, at least in part, a drink container, and in which the drink container is configured to receive a liquid therein. The flexible absorbent panel is also configured to surround, at least in part, the drink container. The flexible absorbent panel is also configured to absorb, at least in part, the liquid once the flexible absorbent panel is positioned, at least in part, proximate to the drink container, and the liquid is inadvertently spilled from the drink container.

To mitigate, at least in part, at least one problem associated with the existing technology, there is provided (in accordance with a fifth major aspect) an apparatus. In accordance with the fifth major embodiment, the apparatus includes and is not limited to (comprises) a receiver assembly defining a mouth. A support assembly is configured to extend, at least in part, radially from the receiver assembly. The support assembly is also configured to selectively securely support, at least in part, a flexible absorbent panel in such a way that the support assembly, in use, positions, at least in part, the flexible absorbent panel at a position that is located proximate to the mouth of the receiver assembly. The flexible absorbent panel provides, at least in part, a void. The void is configured to receive, at least in part, a drink container in such a way that the flexible absorbent panel is positioned between a top section and a bottom section of the drink container, and in which the drink container is configured to receive a liquid therein. The flexible absorbent panel is configured to absorb, at least in part, the liquid once the flexible absorbent panel is positioned, at least in part, proximate to the drink container, and the liquid is inadvertently spilled from the drink container.

To mitigate, at least in part, at least one problem associated with the existing technology, there is provided (in accordance with a sixth major aspect) an apparatus. In accordance with the sixth major embodiment, the apparatus includes and is not limited to (comprises) a flexible absorbent panel providing, at least in part, a void, and in which the void is configured to receive, at least in part, a drink container in such a way that the flexible absorbent panel is positioned between a top section and a bottom section of the drink container. The drink container is configured to receive a liquid therein. A receiver assembly includes a vertically-extending lateral side wall having an upper wall portion and a lower wall portion, and the upper wall portion providing, at least in part, a mouth. The mouth is configured to receive, at least in part, the drink container. The mouth is also configured to be positioned, at least in part, proximate to the vertically-extending lateral side wall of the receiver assembly. The mouth is also configured to correspond, at least in part, with the void of the flexible absorbent panel in such a way that the mouth is registered, at least in part, with the void once the void of the flexible absorbent panel is positioned proximate to the mouth of the receiver assembly. A support assembly is configured to extend, at least in part, radially from the vertically-extending lateral side wall of the receiver assembly. The support assembly is also configured to contact, at least in part, the vertically-extending lateral side wall of the receiver assembly. The support assembly is also configured to surround, at least in part, the vertically-extending lateral side wall of the receiver assembly. The support assembly is also configured to selectively securely support, at least in part, the flexible absorbent panel in such a way that the support assembly, in use, positions, at least in part, the flexible absorbent panel at a position that is located proximate to the mouth of the receiver assembly. The flexible absorbent panel is also configured to absorb, at least in part, the liquid once the flexible absorbent panel is positioned, at least in part, proximate to the drink container, and the liquid is inadvertently spilled from the drink container.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a perspective view of an embodiment of an apparatus preferably for (and not limited to) use with a drink container and also with a drink-holder assembly of a vehicle; and

FIG. 2 depicts a top perspective view of an embodiment of the apparatus and the drink container of FIG. 1; and

FIG. 3 depicts a top perspective view of an embodiment of the apparatus and the drink container of FIG. 1; and

FIG. 4 depicts a top perspective view of an embodiment of the apparatus of FIG. 1; and

FIG. 5 depicts a top perspective view of an embodiment of the apparatus of FIG. 1; and

FIG. 6 depicts a top perspective view of an embodiment of the apparatus of FIG. 1; and

FIG. 7 depicts a top view of an embodiment of the apparatus of FIG. 1; and

FIG. 8 depicts a bottom perspective view of an embodiment of the apparatus of FIG. 1; and

FIG. 9 depicts a side view of an embodiment of the apparatus of FIG. 1; and

FIG. 10 depicts a cross-sectional view of an embodiment of the apparatus of FIG. 1; and

FIG. 11 depicts a top view of an embodiment of the apparatus of FIG. 1; and

FIG. 12 depicts a top view of an embodiment of the apparatus of FIG. 1; and

FIG. 13 depicts a side view of an embodiment of the apparatus of FIG. 1; and

FIG. 14 depicts a side view of an embodiment of the apparatus; and

FIG. 15 depicts a side view of an embodiment of the apparatus; and

FIG. 16 depicts a top view of an embodiment of the apparatus of FIG. 1; and

FIG. 17 depicts a top view of an embodiment of the apparatus of FIG. 1; and

FIG. 18 depicts a top view of an embodiment of the apparatus of FIG. 1; and

FIG. 19 depicts a top perspective view of an embodiment of the apparatus of FIG. 1; and

FIG. 20 depicts a cross-sectional view of an embodiment of the apparatus of FIG. 1; and

FIG. 21 depicts a close-up cross-sectional side view of an embodiment of the apparatus of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 flexible absorbent panel
103 notched panel section
104 void
106 receiver assembly
108 vertically-extending lateral side wall
110 upper wall portion
112 lower wall portion
114 mouth
116 support assembly
117 notched support section
118 panel connector
120 support connector
122 wiper assembly
124 accordion section
126 spaced-apart tapered sections
900 cup receiver
902 drink-holder assembly
904 vehicle
906 drink container
907 container lid
908 liquid
910 top section
912 bottom section

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim defines the invention (in which the claims may be amended during patent examination after filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of to device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

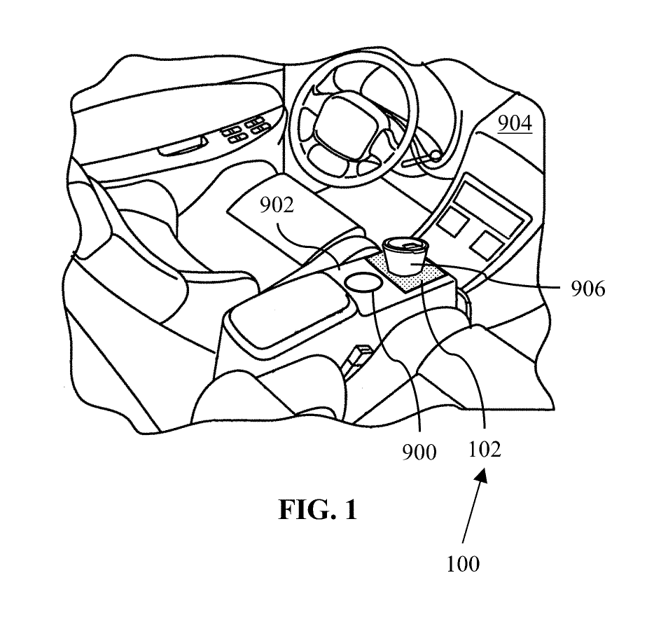

FIG. 1 depicts a perspective view of an embodiment of an apparatus 100 preferably for (and not limited to) use with a drink-holder assembly 902 and also with a drink-holder assembly 902 of a vehicle 904 (as depicted in FIG. 1).

Referring to the embodiment as depicted in FIG. 1, and in accordance with a first major embodiment, the apparatus 100 includes (and is not limited to) a flexible absorbent panel 102. The flexible absorbent panel 102 may be called a flexible liquid-receiving assembly, etc., and any equivalent thereof The flexible absorbent panel 102 may include, for instance, a fabric or a cloth, etc., and any equivalent thereof. The flexible absorbent panel 102 is configured to surround, at least in part, a drink container 906. The drink container 906 is configured to receive a liquid 908 therein. The flexible absorbent panel 102 is also configured to absorb, at least in part, the liquid 908 once (A) the flexible absorbent panel 102 is positioned, at least in part, proximate to the drink container 906, and (B) the liquid 908 is inadvertently spilled from the drink container 906. The drink container 906 may include, for instance, a paper cup, a metal container, etc., and any equivalent thereof The liquid 908 may include, for instance, coffee, a hot beverage, a cold beverage, etc.

In accordance with an embodiment, the first major embodiment is adapted such that the flexible absorbent panel 102 is configured to surround, at least in part, a cup receiver 900 (also called a cup hole, etc.) of a drink-holder assembly 902 once the flexible absorbent panel 102 is positioned proximate to the cup receiver 900. The drink-holder assembly 902 is provided by (positioned in or installed in) the vehicle 904 (as depicted in FIG. 1). The flexible absorbent panel 102 is configured to be positioned proximate to the cup receiver 900. The cup receiver 900 of the drink-holder assembly 902 is configured to receive, at least in part, a drink container 906. The flexible absorbent panel 102 is also configured to surround, at least in part, the drink container 906 once (A) the flexible absorbent panel 102 is positioned to surround, at least in part, the cup receiver 900 of the drink-holder assembly 902, and (B) the drink container 906 is positioned, at least in part, in the cup receiver 900. The vehicle 904 (as depicted in FIG. 1) may include, for instance, a car or a truck, etc., and any equivalent thereof. For instance, as a result of the drink container 906 being moved relative to the cup receiver 900, the flexible absorbent panel 102 is also configured to absorb, at least in part, the liquid 908 once (A) the flexible absorbent panel 102 is positioned, at least in part, proximate to the drink container 906, and (B) the liquid 908 is inadvertently spilled from the drink container 906.

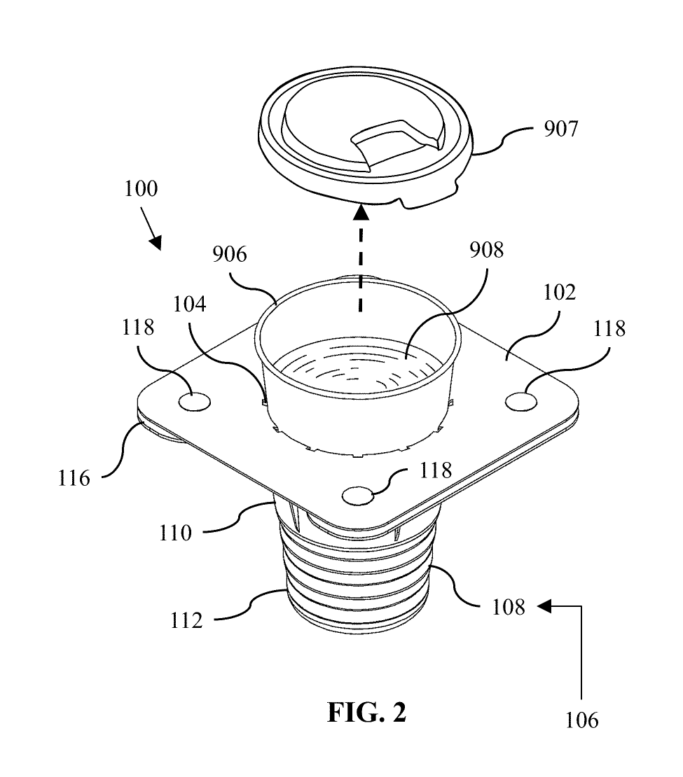

FIG. 2 depicts a top perspective view of an embodiment of the apparatus 100 and the drink-holder assembly 902 of FIG. 1.

Referring to the embodiment as depicted in FIG. 2, the drink container 906 is received in the vertically-extending lateral side wall 108, with the container lid 907 removed from a top section 910 of the drink container 906.

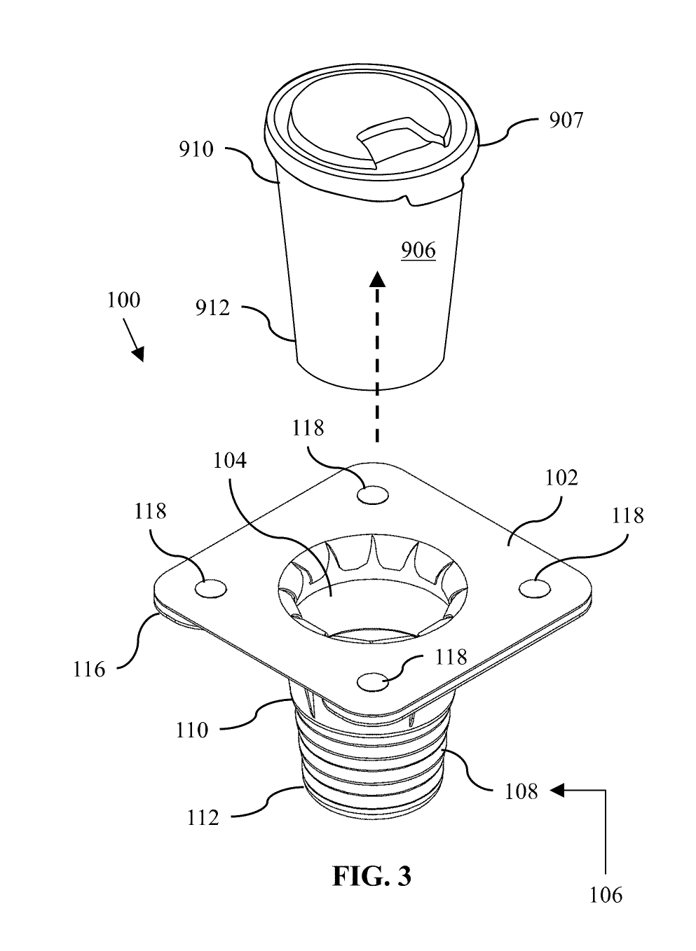

FIG. 3 depicts a top perspective view of an embodiment of the apparatus 100 and the drink-holder assembly 902 of FIG. 1.

Referring to the embodiment as depicted in FIG. 3, the drink container 906 is removed from the vertically-extending lateral side wall 108, with the container lid 907 installed to the top section 910 of the drink container 906.

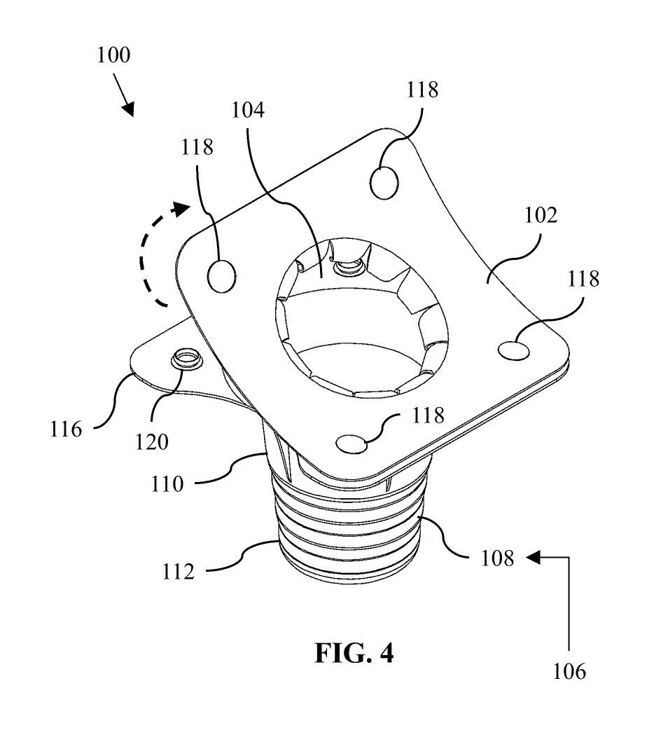

FIG. 4 depicts a top perspective view of an embodiment of the apparatus 100 of FIG. 1.

Referring to the embodiment as depicted in FIG. 4, the flexible absorbent panel 102 is partially removed from (partially separated from) the support assembly 116.

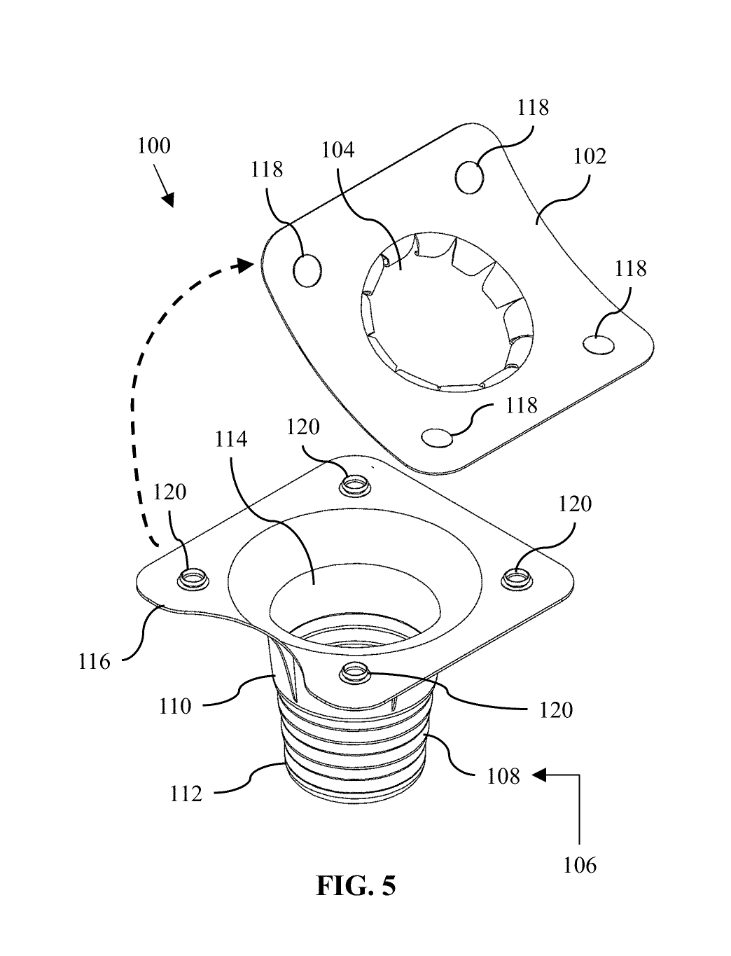

FIG. 5 depicts a top perspective view of an embodiment of the apparatus 100 of FIG. 1.

Referring to the embodiment as depicted in FIG. 5, the flexible absorbent panel 102 is removed from (separated from or detached from) the support assembly 116.

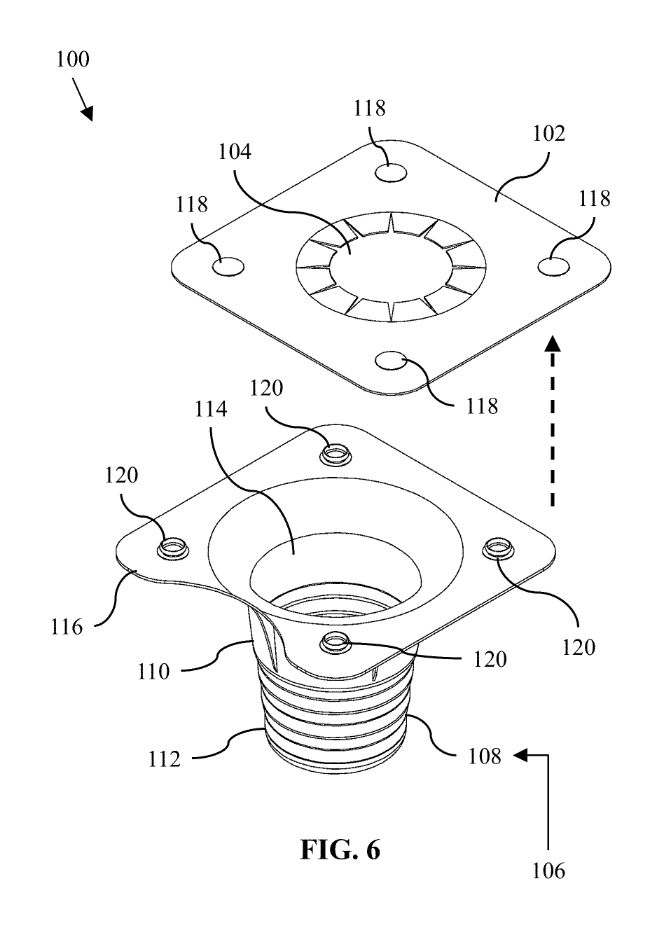

FIG. 6 depicts a top perspective view of an embodiment of the apparatus 100 of FIG. 1.

Referring to the embodiment as depicted in FIG. 6, the flexible absorbent panel 102 is positioned above the support assembly 116.

Referring to the embodiments as depicted in FIG. 2 to FIG. 6, the flexible absorbent panel 102 defines, at least in part, a void 104. The void 104 is configured to receive, at least in part, the drink container 906. The void 104 is configured to be positioned, at least in part, over, and registered, at least in part, with the cup receiver 900 of the drink-holder assembly 902. The void 104 is configured to permit, at least in part, the cup receiver 900 of the drink-holder assembly 902 to receive, at least in part, the drink container 906.

Preferably, the container lid 907 is configured to be selectively attachable to, and selectively detachable from, the top section 910 of the drink container 906.

Referring to the embodiments as depicted in FIG. 2 to FIG. 6, and in accordance with a second major embodiment, the apparatus 100 includes (and is not limited to) a synergistic combination of a receiver assembly 106 and a support assembly 116 (the flexible absorbent panel 102 is an optional item).

The receiver assembly 106 defines (provides) a mouth 114. The support assembly 116 is configured to extend, at least in part, radially from the receiver assembly 106. The support assembly 116 is also configured to selectively securely support, at least in part, the flexible absorbent panel 102. This is done in such a way that the support assembly 116, in use, positions, at least in part, the flexible absorbent panel 102 at a position that is located proximate to the mouth 114 of the receiver assembly 106. The flexible absorbent panel 102, in use, provides, at least in part, a void 104. The void 104 is configured to receive, at least in part, a drink container 906. This is done in such a way that the flexible absorbent panel 102 is positioned between a top section 910 and a bottom section 912 of the drink container 906, and in which the drink container 906 is configured to receive a liquid 908 therein. The flexible absorbent panel 102 is also configured to absorb, at least in part, the liquid 908 once (A) the flexible absorbent panel 102 is positioned, at least in part, proximate to the drink container 906, and (B) the liquid 908 is inadvertently spilled from the drink container 906.

In accordance with an embodiment, the second major embodiment is adapted such that the receiver assembly 106 is configured to be received, at least in part, in a drink-holder assembly 902 of a vehicle 904 (as depicted in FIG. 1). The receiver assembly 106 defines the mouth 114 configured to be received, at least in part, in the drink-holder assembly 902. The flexible absorbent panel 102 is configured to surround, at least in part, the cup receiver 900 of the drink-holder assembly 902 of the vehicle 904.

In accordance with an embodiment, the second major embodiment is adapted such that the support assembly 116 is configured to extend, at least in part, radially from the receiver assembly 106. The support assembly 116 is also configured to selectively securely support, at least in part, the flexible absorbent panel 102 (this is done in such a way that the support assembly 116, in use, positions, at least in part, the flexible absorbent panel 102 at a position that is located proximate to the mouth 114 of the receiver assembly 106). The support assembly 116 is also configured to selectively securely support, at least in part, the flexible absorbent panel 102 proximate to the mouth 114 of the receiver assembly 106.

The second major embodiment is adapted such that (A) the receiver assembly 106 defines the mouth 114 configured to be received, at least in part, in the drink-holder assembly 902 of a vehicle 904 (as depicted in FIG. 1), and (B) the flexible absorbent panel 102 is configured to surround, at least in part, the cup receiver 900 of the drink-holder assembly 902 of the vehicle 904.

In accordance with a preferred option, the void 104 is centrally positioned on the flexible absorbent panel 102.

Referring to the embodiments as depicted in FIG. 2 to FIG. 6, and in accordance with a third major embodiment, the apparatus 100 includes (and is not limited to) a synergistic combination of a flexible absorbent panel 102, a receiver assembly 106 and a support assembly 116.

The flexible absorbent panel 102 provides (defines), at least in part, a void 104. The void 104 is configured to receive, at least in part, a drink container 906, and this is done in such a way that the flexible absorbent panel 102 is positioned between a top section 910 and a bottom section 912 of the drink container 906. The drink container 906 is configured to receive a liquid 908 therein (such as, coffee, a hot beverage, etc.).

The receiver assembly 106 includes a vertically-extending lateral side wall 108 having an upper wall portion 110 and a lower wall portion 112. The upper wall portion 110 provides (defines), at least in part, a mouth 114. The mouth 114 is configured to receive, at least in part, the drink container 906. The mouth 114 is also configured to be positioned, at least in part, proximate to the vertically-extending lateral side wall 108 of the receiver assembly 106. The mouth 114 is also configured to correspond, at least in part, with the void 104 of the flexible absorbent panel 102, and this is done in such a way that the mouth 114 is registered, at least in part, with the void 104 once the void 104 of the flexible absorbent panel 102 is positioned proximate to the mouth 114 of the receiver assembly 106.

The support assembly 116 may be called a flap structure. The support assembly 116 is configured to extend, at least in part, radially from the vertically-extending lateral side wall 108 of the receiver assembly 106. The support assembly 116 is also configured to contact, at least in part, the vertically-extending lateral side wall 108 of the receiver assembly 106. The support assembly 116 is also configured to surround, at least in part, the vertically-extending lateral side wall 108 of the receiver assembly 106. The support assembly 116 is also configured to selectively securely support, at least in part, the flexible absorbent panel 102 proximate to the mouth 114 of the receiver assembly 106. The flexible absorbent panel 102 is also configured to absorb, at least in part, a liquid 908 once the flexible absorbent panel 102 is positioned, at least in part, proximate to the drink container 906, and the liquid 908 is (becomes) inadvertently spilled from the drink container 906 (for instance, as a result of the drink container 906 being moved relative to the cup receiver 900).

In accordance with an embodiment, the third major embodiment is adapted such that the receiver assembly 106 is configured to be received, at least in part, in a drink-holder assembly 902 of a vehicle 904 (as depicted in FIG. 1). Preferably, the receiver assembly 106 is configured to be supported, at least in part, by the drink-holder assembly 902. The receiver assembly 106 is configured to be received, at least in part, in a drink-holder assembly 902 of a vehicle 904. The flexible absorbent panel 102 is configured to surround, at least in part, the cup receiver 900 of the drink-holder assembly 902 of the vehicle 904.

Referring to the embodiments as depicted in FIG. 2 to FIG. 6, the support assembly 116 is configured to selectively securely support the flexible absorbent panel 102 proximate to the mouth 114 of the receiver assembly 106. This is done in such a way that the mouth 114 of the receiver assembly 106 is coaxially aligned with the void 104 of the flexible absorbent panel 102 (once the support assembly 116 receives, at least in part, the flexible absorbent panel 102 proximate to the mouth 114 of the receiver assembly 106).

Referring to the embodiments as depicted in FIG. 2 to FIG. 6, the support assembly 116 is configured to selectively securely support the flexible absorbent panel 102 proximate to the mouth 114 of the receiver assembly 106. This is done in such a way that the flexible absorbent panel 102, in use, receives, at least in part, and retains, at least in part, the liquid 908 that is (becomes) inadvertently spilled from the drink container 906.

Referring to the embodiments as depicted in FIG. 2 to FIG. 6, the mouth 114 is configured to be positioned proximate to the vertically-extending lateral side wall 108 of the receiver assembly 106 at a position that is located proximate to the upper wall portion 110 of the vertically-extending lateral side wall 108.

In accordance with a preferred embodiment, the void 104 is centrally positioned on the flexible absorbent panel 102.

In accordance with a preferred embodiment, the lower wall portion 112 is provided, at least in part, at the lower section of the vertically-extending lateral side wall 108. The lower wall portion 112 extends radially inwards from the vertically-extending lateral side wall 108. In accordance with a preferred embodiment, the mouth 114 is configured to be spaced apart from the lower wall portion 112. In accordance with a preferred embodiment, the mouth 114 is configured to contact, at least in part, the vertically-extending lateral side wall 108 of the receiver assembly 106 at a position that is located above the lower wall portion 112.

In accordance with a preferred embodiment, the lower wall portion 112 is configured to capture, at least in part, the liquid 908 that is (becomes) inadvertently spilled from the drink container 906. It will be appreciated that, as an option, the lower wall portion 112 may not exist or be provided (if so desired).

In accordance with a preferred embodiment, the support assembly 116 is also configured to selectively attach to and detach from the flexible absorbent panel 102. Preferably, the flexible absorbent panel 102 includes a panel connector 118 (such as a female snap-click connector, touch connector, the VELCRO (TRADEMARK) connector, and any equivalent thereof). The support assembly 116 includes a support connector 120 (such as a male snap-click connector, a touch connector, the VELCRO (TRADEMARK) connector, and any equivalent thereof). The panel connector 118 and the support connector 120 are configured to be selectively connectable with, and selectively dis-connectable from, each other. Preferably, each corner section of the flexible absorbent panel 102 includes the panel connector 118, and each corner section of the support assembly 116 includes the support connector 120.

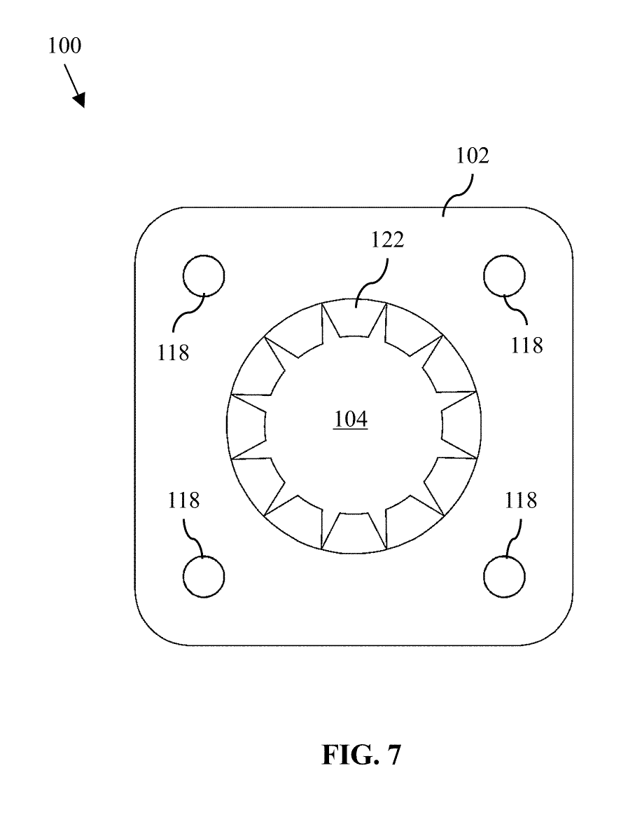

FIG. 7 depicts a top view of an embodiment of the apparatus 100 of FIG. 1.

Referring to the embodiment as depicted in FIG. 7, the flexible absorbent panel 102 includes a wiper assembly 122 configured to receive condensation from the side wall of the drink container 906. Preferably, the wiper assembly 122 is configured to wipe off condensation (from cups having a colder drink), such as once the drink container 906 is moved relative to the wiper assembly 122 (as depicted in FIG. 2).

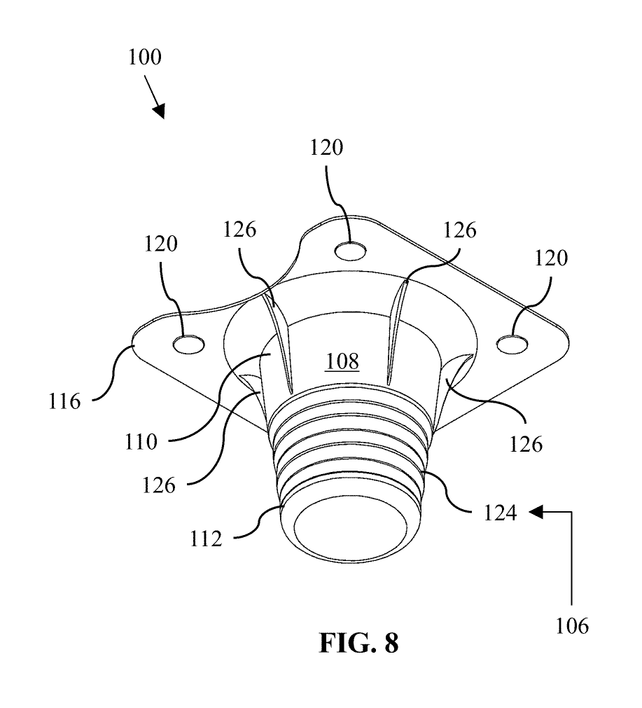

FIG. 8 depicts a bottom perspective view of an embodiment of the apparatus 100 of FIG. 1.

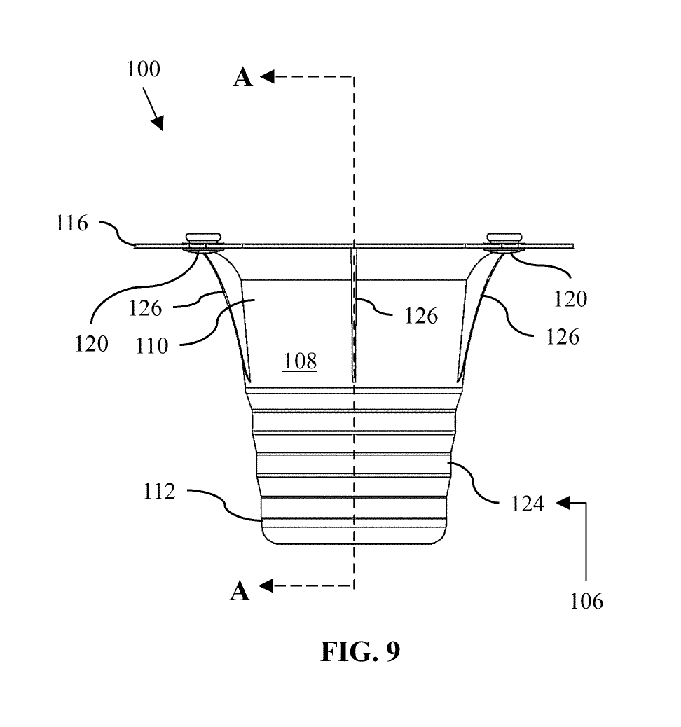

FIG. 9 depicts a side view of an embodiment of the apparatus 100 of FIG. 1.

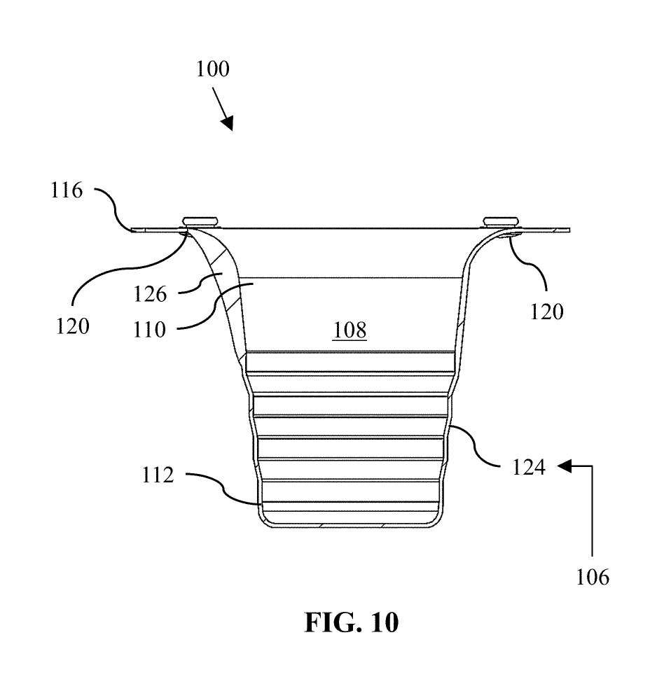

FIG. 10 depicts a cross-sectional view of an embodiment of the apparatus 100 of FIG. 1. The cross-sectional view is taken along a cross-sectional line A-A, as depicted in FIG. 9.

Referring to the embodiments as depicted in FIGS. 8, 9 and 10, the receiver assembly 106 includes an accordion section 124 configured to selectively expand, and to selectively contract, a vertical height of the receiver assembly 106. This is done in such a way that the receiver assembly 106, in use, is receivable (fits), at least in part, into a fixed vertical depth (the various vertical fixed depths) of the drink-holder assembly 902 (as depicted in FIGS. 1, 13, 14 and 15). Advantageously, the accordion section 124 permits the receiver assembly 106 to be usable for a relatively wider range of types of the drink-holder assembly 902.

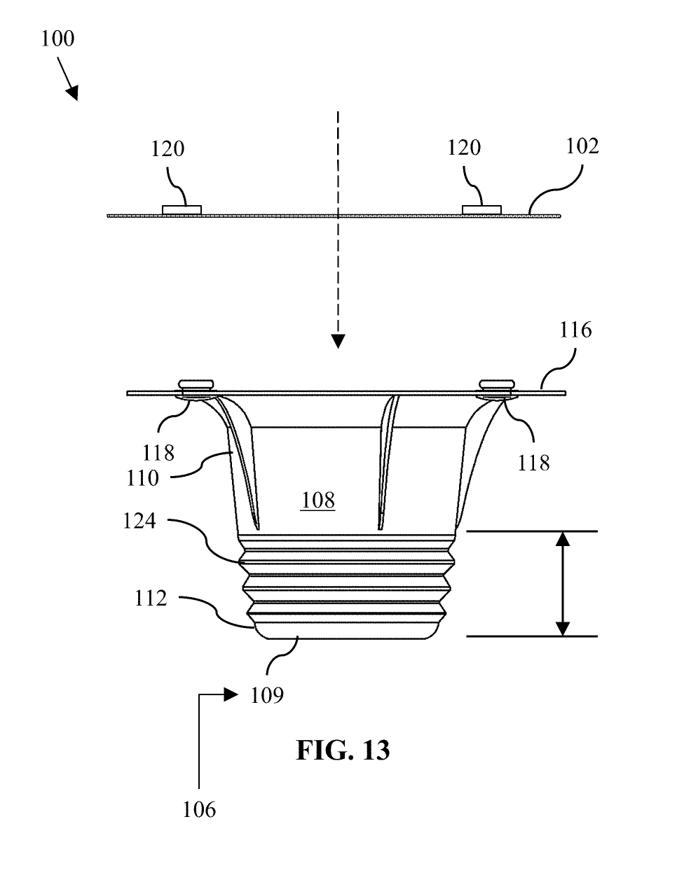

Referring to the embodiments as depicted in FIGS. 8, 9 and 10, the support assembly 116 includes spaced-apart tapered sections 126 positioned beneath the support assembly 116. The spaced-apart tapered sections 126 connect portions of the upper wall portion 110 to the support assembly 116. The spaced-apart tapered sections 126 are configured to accommodate or interface with various sized openings of the drink-holder assembly 902 (as associated with different automobiles having different cup holder sizes), as depicted in FIGS. 13, 14 and 15.

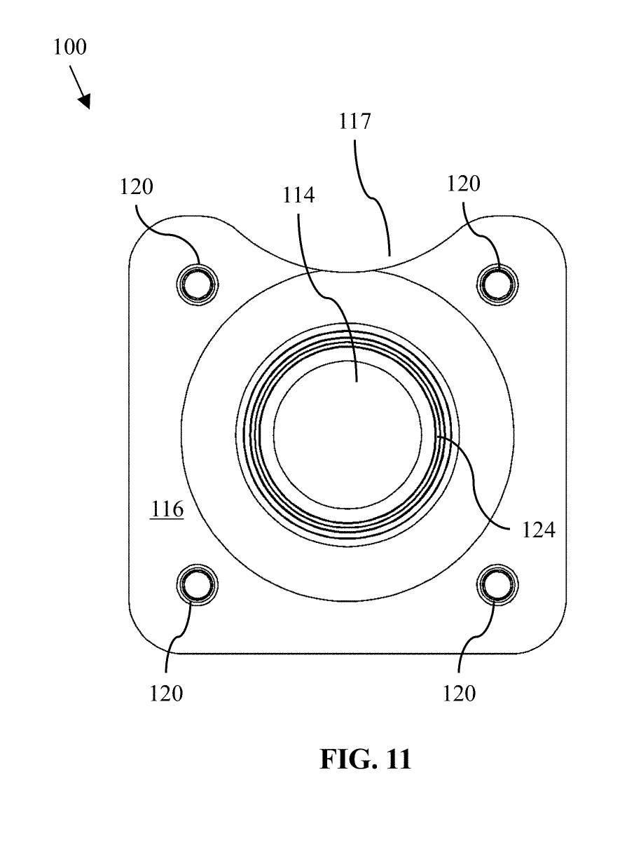

FIG. 11 depicts a top view of an embodiment of the apparatus 100 of FIG. 1.

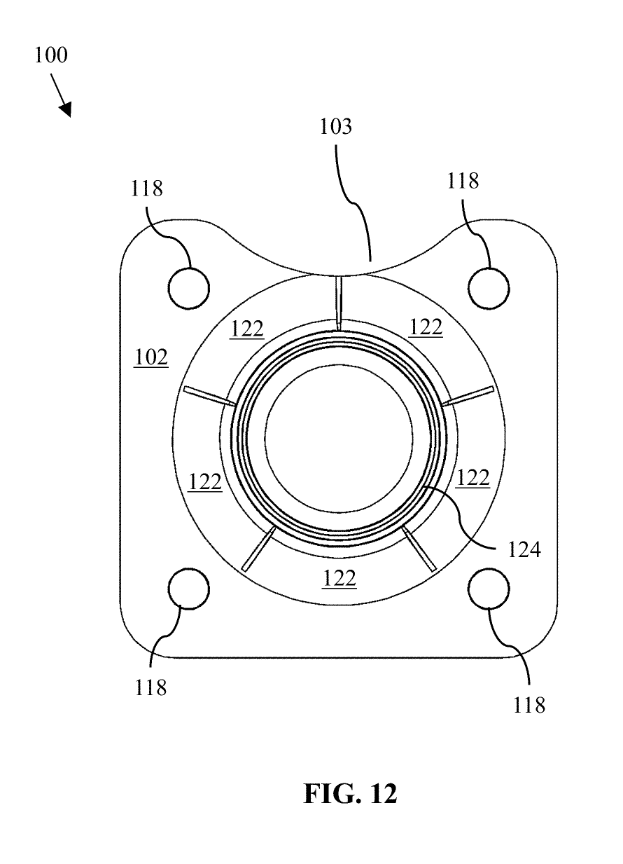

FIG. 12 depicts a top view of an embodiment of the apparatus 100 of FIG. 1.

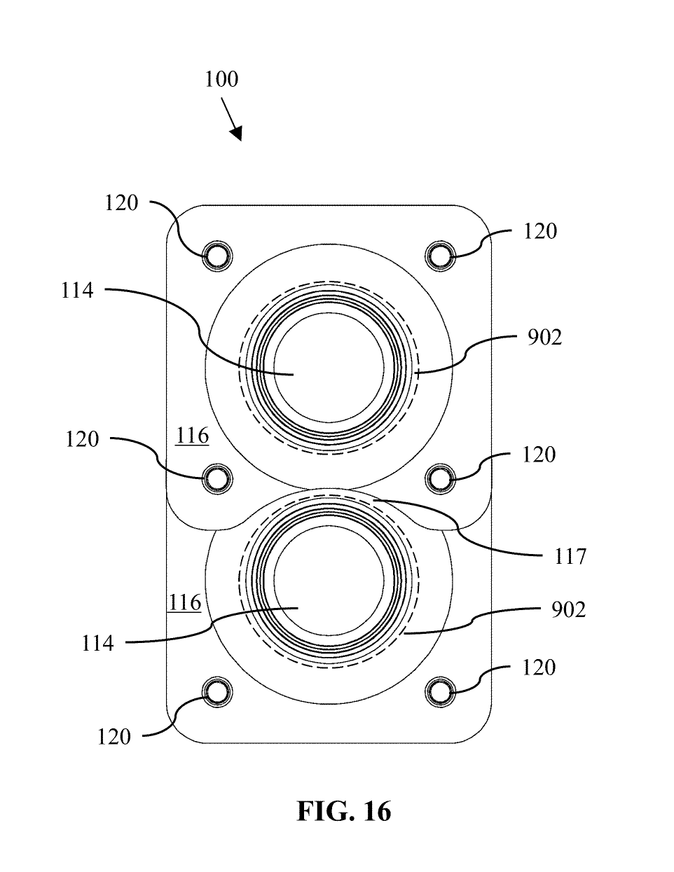

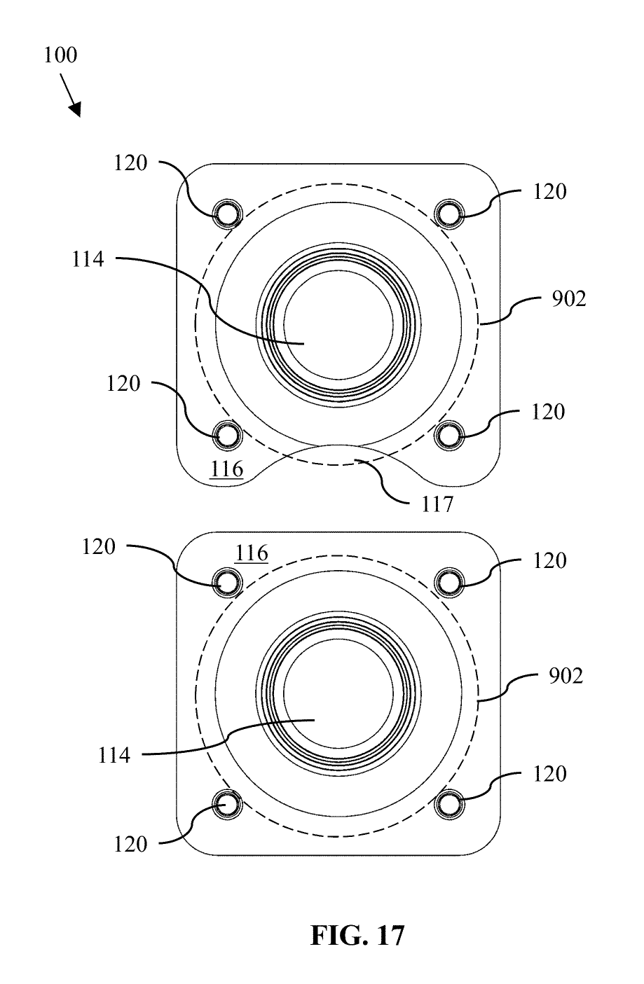

Referring to the embodiment as depicted in FIG. 11, the support assembly 116 defines a notched support section 117. Further explanation for the purpose of the notched support section 117 is provided by the description associated with FIGS. 16 and 17.

Referring to the embodiment as depicted in FIG. 12, the flexible absorbent panel 102 defines a notched panel section 103. The notched panel section 103 is configured to correspond to the notched support section 117 of the support assembly 116 as depicted in FIG. 11. Further explanation for the purpose of the notched panel section 103 is provided by the description associated with FIGS. 16 and 17.

FIG. 13 depicts a side view of an embodiment of the apparatus 100 of FIG. 1.

Referring to the embodiment as depicted in FIG. 13, the flexible absorbent panel 102 is positioned over the support assembly 116. The accordion section 124 is depicted in a collapsed state, in which the bottom wall 109 is positioned close to the support assembly 116 (for convenient storage). The accordion section 124 is configured to selectively position the bottom wall 109 at a selectable position (relative to the support assembly 116).

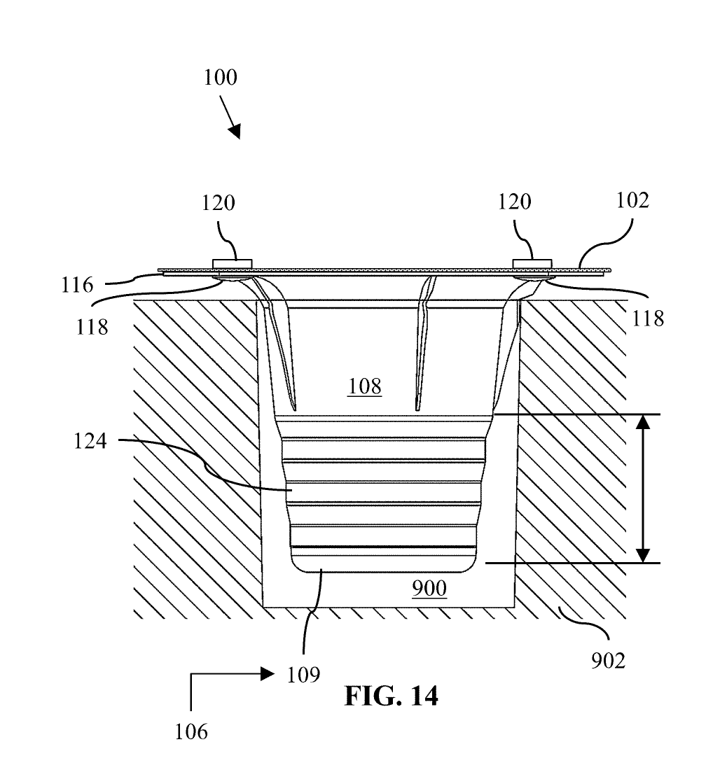

FIG. 14 depicts a side view of an embodiment of the apparatus 100 of FIG. 1.

Referring to the embodiment as depicted in FIG. 14, the flexible absorbent panel 102 is attached to the support assembly 116. This is done in such a way that the flexible absorbent panel 102, in use, covers (at least in part) the top surface of the support assembly 116. The receiver assembly 106 is received (at least in part) in the cup receiver 900 of the drink-holder assembly 902. The accordion section 124 is expanded (elongated) into the interior of the cup receiver 900. The spaced-apart tapered sections 126 are configured to facilitate improved fitting of the apparatus 100 to various sizes of the drink-holder assembly 902 (as depicted in FIG. 14).

The accordion section 124 is expanded so that the bottom wall 109 of the upper wall portion 110 reaches toward (is placed closer to) the bottom wall of the drink-holder assembly 902.

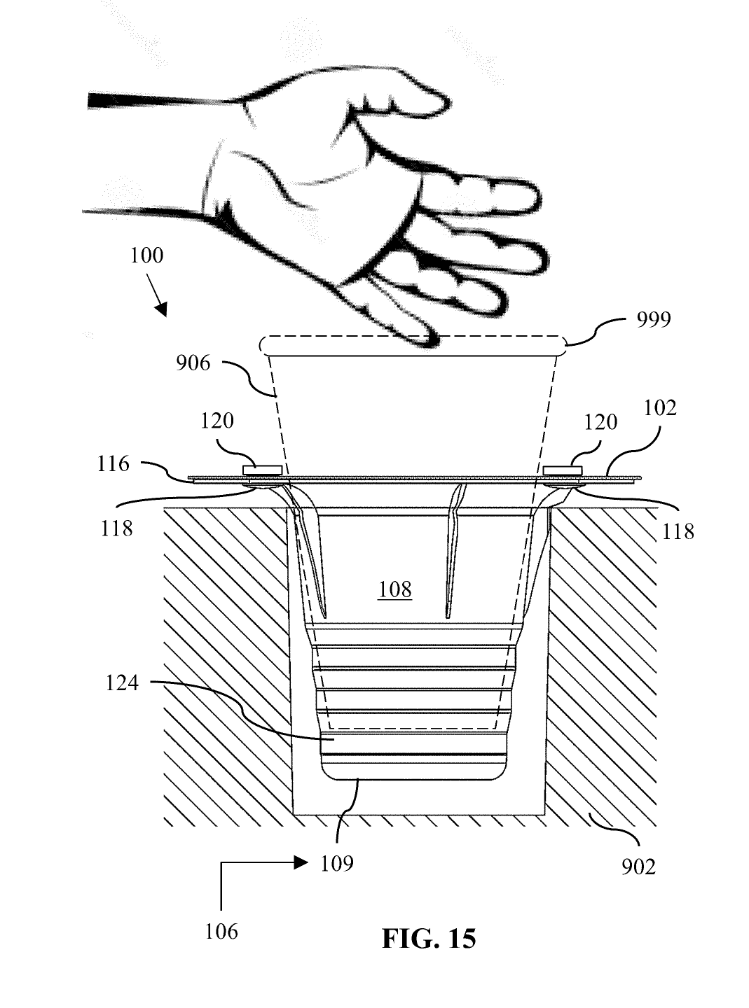

FIG. 15 depicts a side view of an embodiment of the apparatus 100 of FIG. 1.

Referring to the embodiment as depicted in FIG. 15, the drink container 906 is received (at least in part) in the receiver assembly 106.

FIG. 16 depicts a top view of an embodiment of the apparatus 100 of FIG. 1.

Referring to the embodiment as depicted in FIG. 16, the flexible absorbent panel 102 and the support assembly 116 are positioned in such a way that a notched panel section 113 of the flexible absorbent panel 102 and a notched support section 117 of the support assembly 116 are lined up with each other. This is done in such a way that the apparatus 100 may be positioned immediately adjacent to another instance of the apparatus 100.

The case is depicted in which instances of the drink-holder assembly 902 are spaced apart from each other (one another) by a relatively smaller distance (compared to the embodiment as depicted in FIG. 17). For this case, the instances of the apparatus 100 are spaced apart (separated) from each other (one another) so that the instances of the apparatus 100, in use, touch or contact each other (one another or one against the other). Preferably, the outer peripheral edge of the support assembly 116 forms a square shape.

FIG. 17 depicts a top view of an embodiment of the apparatus 100 of FIG. 1.

Referring to the embodiment as depicted in FIG. 17, the case is depicted in which the instances of the drink-holder assembly 902 are spaced apart from each other by a relatively larger distance (compared to the embodiment as depicted in FIG. 16). For this case, the instances of the apparatus 100 are spaced apart (separated) from each other so that the instances of the apparatus 100 do not touch or contact each other. Preferably, the outer peripheral edge of the support assembly 116 forms a square shape.

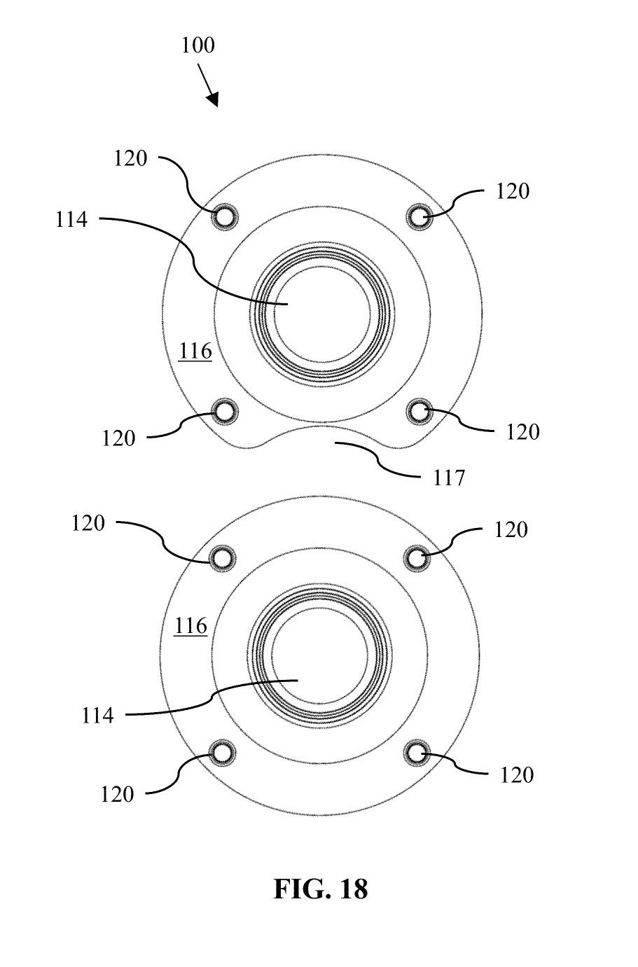

FIG. 18 depicts a top view of an embodiment of the apparatus 100 of FIG. 1.

Referring to the embodiment as depicted in FIG. 18, the outer peripheral edge of the support assembly 116 forms a circular shape.

Referring to the embodiments as depicted in FIGS. 16, 17 and 18, a first instance of the support assembly 116 includes the notched support section 117. A second instance of the support assembly 116 does not include the notched support section 117. The first instance of the support assembly 116 and the second instance of the support assembly 116 may be positioned closer to each other as a result of the notched support section 117 (to better accommodate the specific geometry of the cup receiver 900 of the drink-holder assembly 902, as depicted in FIG. 1). As depicted in FIG. 1, a first instance of the cup receiver 900 is positioned adjacent to a second instance of the cup receiver 900 of the drink-holder assembly 902. The notched support section 117 assists in accommodating the specific geometry of (position of) the cup receivers 900.

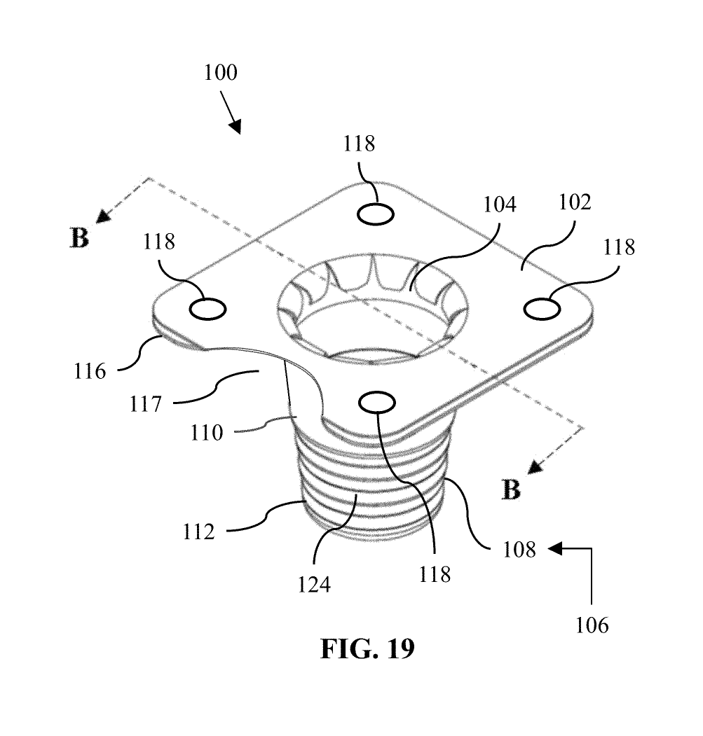

FIG. 19 depicts a top perspective view of an embodiment of the apparatus 100 of FIG. 1.

Referring to the embodiment as depicted in FIG. 19, the flexible absorbent panel 102 and the support assembly 116 are positioned in such a way that the notched panel section 113 of the flexible absorbent panel 102 and the notched support section 117 of the support assembly 116 are lined up with each other. This is done in such a way that the apparatus 100 may be positioned immediately adjacent to another instance of the apparatus 100 (as depicted in FIG. 16).

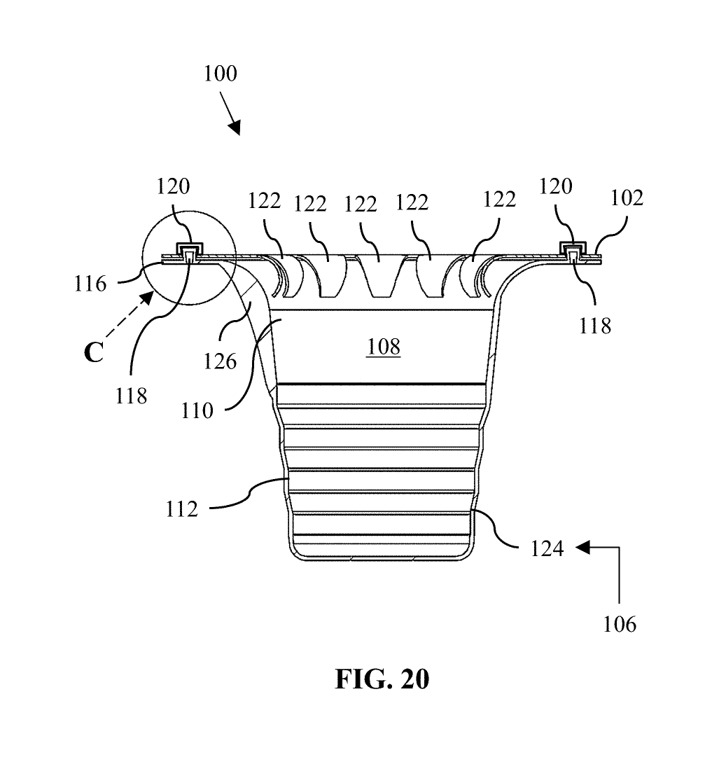

FIG. 20 depicts a cross-sectional view of an embodiment of the apparatus 100 of FIG. 1. The cross-sectional view is taken along a cross-sectional line B-B depicted in FIG. 19.

Referring to the embodiment as depicted in FIG. 20, the accordion section 124 is depicted in an expanded condition or state. The panel connector 118 of the support assembly 116 is positioned at the outer periphery zone of the support assembly 116. The support connector 120 of the flexible absorbent panel 102 is positioned at the outer periphery zone of the flexible absorbent panel 102. Preferably, the support connector 120, in use, covers the panel connector 118 once the support connector 120 connects to the panel connector 118. The spaced-apart tapered sections 126 are configured to facilitate the improved fitting of the apparatus 100 to various sizes of the drink-holder assembly 902 (as depicted in FIG. 14).

Preferably, the wiper assembly 122 extends downwardly into the interior of the apparatus 100. The wiper assembly 122 is configured to wipe (remove) condensation from the drink container 906 (such as a cup) once the drink container 906 is moved relative to the wiper assembly 122. Alternatively, the condensation from the drink container 906, in use, drips downwardly along the side wall of the drink container 906 to contact the wiper assembly 122. Preferably, the wiper assembly 122 includes spaced apart tapered pieces extending from the flexible absorbent panel 102.

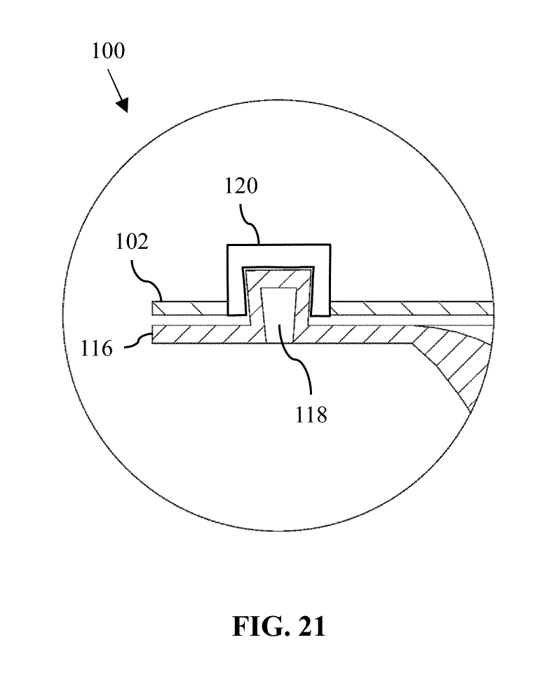

FIG. 21 depicts a close-up cross-sectional side view of an embodiment of the apparatus 100 of FIG. 1. The close-up view of FIG. 21 is from a circle C depicted in FIG. 20.

Referring to the embodiment as depicted in FIG. 21, the panel connector 118 and the support connector 120 are configured to be selectively connectable and selectively disconnectable from each other (snap connectable and snap disconnectable). This is done in such a way that the flexible absorbent panel 102 and the support assembly 116, in use, and at least in part, contact each other, and the flexible absorbent panel 102, in use, rests relatively flat on the support assembly 116 (in a flat condition). Preferably, at least a portion of the panel connector 118 is configured to be securely received in an interior of the support connector 120.

The following is offered as further description of the embodiments, in which any one or more of any technical feature (described in the detailed description, the summary and the claims) may be combinable with any another one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a flexible absorbent panel being configured to surround, at least in part, a drink container, and in which the drink container is configured to receive a liquid therein; and
the flexible absorbent panel also being configured to surround, at least in part, the drink container; and
the flexible absorbent panel also being configured to absorb, at least in part, the liquid once the flexible absorbent panel is positioned, at least in part, proximate to the drink container, and the liquid is inadvertently spilled from the drink container.

2. The apparatus of claim 1, wherein:
the flexible absorbent panel is configured to surround, at least in part, a cup receiver of a drink-holder assembly once the flexible absorbent panel is positioned proximate to the cup receiver, in which the cup receiver of the drink-holder assembly is configured to receive, at least in part, the drink container; and
the flexible absorbent panel also being configured to surround, at least in part, the drink container once the flexible absorbent panel is positioned to surround, at least in part, the cup receiver of the drink-holder assembly, and the drink container is positioned, at least in part, in the cup receiver.

3. The apparatus of claim 2, wherein:
the flexible absorbent panel defines, at least in part, a void configured to receive, at least in part, the drink container; and
wherein the void is configured to be positioned, at least in part, over, and registered, at least in part, with the cup receiver of the drink-holder assembly; and
the void is configured to permit, at least in part, the cup receiver of the drink-holder assembly to receive, at least in part, the drink container.

4. An apparatus, comprising:
a receiver assembly defining a mouth; and
a support assembly being configured to extend, at least in part, radially from the receiver assembly; and
the support assembly also being configured to selectively securely support, at least in part, a flexible absorbent panel in such a way that the support assembly, in use, positions, at least in part, the flexible absorbent panel at a position that is located proximate to the mouth of the receiver assembly, and in which the flexible absorbent panel provides, at least in part, a void, in which the void is configured to receive, at least in part, a drink container in such a way that the flexible absorbent panel is positioned between a top section and a bottom section of the drink container, and in which the drink container is configured to receive a liquid therein; and
the flexible absorbent panel being configured to absorb, at least in part, the liquid once the flexible absorbent panel is positioned, at least in part, proximate to the drink container, and the liquid is inadvertently spilled from the drink container.

5. The apparatus of claim 4, wherein:
the receiver assembly is configured to be received, at least in part, in a drink-holder assembly of a vehicle; and
the receiver assembly defines the mouth configured to be received, at least in part, in the drink-holder assembly; and
the flexible absorbent panel is configured to surround, at least in part, a cup receiver of the drink-holder assembly of the vehicle.

6. The apparatus of claim 5, wherein:
the void is centrally positioned on the flexible absorbent panel.

7. An apparatus, comprising:
a flexible absorbent panel providing, at least in part, a void, and in which the void is configured to receive, at least in part, a drink container in such a way that the flexible absorbent panel is positioned between a top section and a bottom section of the drink container, in which the drink container is configured to receive a liquid therein; and
a receiver assembly including a vertically-extending lateral side wall having an upper wall portion and a lower wall portion, and the upper wall portion providing, at least in part, a mouth; and
the mouth being configured to receive, at least in part, the drink container; and
the mouth also being configured to be positioned, at least in part, proximate to the vertically-extending lateral side wall of the receiver assembly; and
the mouth also being configured to correspond, at least in part, with the void of the flexible absorbent panel in such a way that the mouth is registered, at least in part, with the void once the void of the flexible absorbent panel is positioned proximate to the mouth of the receiver assembly; and
a support assembly being configured to extend, at least in part, radially from the vertically-extending lateral side wall of the receiver assembly; and
the support assembly also being configured to contact, at least in part, the vertically-extending lateral side wall of the receiver assembly; and
the support assembly also being configured to surround, at least in part, the vertically-extending lateral side wall of the receiver assembly; and
the support assembly also being configured to selectively securely support, at least in part, the flexible absorbent panel in such a way that the support assembly, in use, positions, at least in part, the flexible absorbent panel at a position that is located proximate to the mouth of the receiver assembly; and
the flexible absorbent panel being configured to absorb, at least in part, the liquid once the flexible absorbent panel is positioned, at least in part, proximate to the drink container, and the liquid is inadvertently spilled from the drink container.

8. The apparatus of claim 7, wherein:
the receiver assembly is configured to be received, at least in part, in a drink-holder assembly; and
the receiver assembly is configured to be received, at least in part, in the drink-holder assembly of a vehicle; and
the flexible absorbent panel is configured to surround, at least in part, a cup receiver of the drink-holder assembly of the vehicle.

9. The apparatus of claim 7, wherein:
the support assembly is configured to selectively securely support the flexible absorbent panel proximate to the mouth of the receiver assembly in such a way that the mouth of the receiver assembly is coaxially aligned with the void of the flexible absorbent panel once the support assembly receives, at least in part, the flexible absorbent panel proximate to the mouth of the receiver assembly.

10. The apparatus of claim 7, wherein:
the support assembly is configured to selectively securely support the flexible absorbent panel proximate to the mouth of the receiver assembly in such a way that the flexible absorbent panel, in use, receives, at least in part, and retains, at least in part, the liquid that is inadvertently spilled from the drink container.

11. The apparatus of claim 7, wherein:
the mouth is configured to be positioned proximate to the vertically-extending lateral side wall of the receiver assembly at the position that is located proximate to the upper wall portion of the vertically-extending lateral side wall.

12. The apparatus of claim 7, wherein:
the void is centrally positioned on the flexible absorbent panel.

13. The apparatus of claim 7, wherein:
the support assembly is also configured to selectively attach to and detach from the flexible absorbent panel.

14. The apparatus of claim 7, wherein:
the lower wall portion is provided, at least in part, at the lower wall portion of the vertically-extending lateral side wall, and the lower wall portion extends radially inwards from the vertically-extending lateral side wall.

15. The apparatus of claim 7, wherein:
the mouth is spaced apart from the lower wall portion; and
the mouth is configured to contact, at least in part, the vertically-extending lateral side wall of the receiver assembly at the position that is located above the lower wall portion.

16. The apparatus of claim 7, wherein:
the lower wall portion is configured to capture, at least in part, the liquid that is inadvertently spilled from the drink container.

17. The apparatus of claim 7, wherein:
the flexible absorbent panel includes a panel connector; and
the support assembly includes a support connector; and
the panel connector and the support connector are configured to be selectively connectable with, and selectively dis-connectable from, each other.

18. The apparatus of claim 7, wherein:
the flexible absorbent panel includes:
a wiper assembly configured to receive condensation.

19. The apparatus of claim 7, wherein:
the receiver assembly includes:
an accordion section configured to selectively expand, and to selectively contract, a vertical height of the receiver assembly in such a way that the receiver assembly, in use, is receivable, at least in part, into a fixed vertical depth of a drink-holder assembly.

20. The apparatus of claim 7, wherein:
the support assembly includes spaced-apart tapered sections positioned beneath the support assembly; and
the spaced-apart tapered sections connect portions of the upper wall portion to the support assembly; and
the spaced-apart tapered sections are configured to accommodate or interface with various sized openings of a drink-holder assembly.
